(19) United States
(12) Patent Application Publication
(10) Pub. No.: US 2004/0103052 A1
(43) Pub. Date: May 27, 2004

(54) System and method for valuing investment opportunities using real options, creating heuristics to approximately represent value, and maximizing a portfolio of investment opportunities within specified objectives and constraints

(76) Inventor: Gill R. Eapen, Groton, CT (US)

Correspondence Address: LITMAN LAW OFFICES, LTD., P.O. BOX 15035 CRYSTAL CITY STATION, ARLINGTON, VA, 22215, US

(21) Appl. No.: 10/303,701

(22) Filed: Nov. 26, 2002

(51) Int. Cl. G06F 17/60

(52) U.S. Cl. 705/36

(57) ABSTRACT

A system and method for valuing investment opportunities using real options, creating heuristics to approximately represent value, and maximizing a portfolio of investment opportunities within specified objectives and constraints. The system and method provides a problem solving environment for graphically representing complex valuation and decision problems, valuing them using real option analysis or discounted cash flow analysis, and creating heuristics between value and fundamental parameters. The system allows a user to graphically create a decision problem that allows combining options of both American and European types, fixed cash flows, and probabilities of technical success in whatever sequence is needed. The system also enables a user to describe parameters of the decision problem in names or in numbers in preformatted sheets or make connections to existing databases that hold the necessary information. Built in intelligence provides a user with on-demand tools to calculate valuation parameters.

### BACKGROUND OF THE INVENTION

1. Field of the Invention

The present invention relates generally to the modeling and analysis environment for investment decisions involving real or financial assets and, more particularly to graphical modeling, knowledge based parameterization of a problem, heuristics development, and portfolio maximization.

2. Description of the Related Art

Decision makers in companies, venture capital, and private equity funds often need to find the value of an investment proposal and associated return on investments to make the right decisions. These investments are typically in real assets, as opposed to financial assets, in products, technologies, intellectual properties, and/or companies. Traditional techniques, such as DISCOUNTED CASH FLOW, often fail to assess the value of these types of assets because they ignore two important characteristics of the investment problem: (1) revenues, costs, and cash flows associated with these investments are stochastic (e.g., they are not predictable precisely); and (2) flexibility is present in the timing, sequencing, and intensity of investment choices.

Although this problem is well researched, there have not been methodologies and tools that are practical for decision makers to employ in their decision processes. A number of reasons for this are as follows.

(a) Most decision problems contain a sequence of decisions and closed form solutions, such as the Black-Scholes equation, are not available.

(b) There have not been intuitive graphical frameworks to represent decision problems that typically include options, fixed cash flows, and probabilities of technical success.

(c) Practical decision problems, as opposed to text book problems or more easily tractable financial problems, generally involve multiple sequence of cash flows with varying stochastic and probabilistic characteristics, and multiple choices at various decision points. As such, these are complex problems to solve numerically and systems that solve these problems and obtain results that are usable in real decision solutions are lacking.

(d) There has not been an integrated environment that provides both a way to model the problem as well as create parameters needed to solve it using historically available data either from the market or from internal databases.

(e) Earlier attempts at solving these types of problems relied on more mathematically complex but less dimensionally flexible techniques, such as partial differential equations and/or binomial trees leading to solving simple problems with theoretically derived constraints but not real problems faced by decision makers.

(f) Specific problem solutions have not been extended to creating more practical heuristics to help decision makers for recurring problems.

(g) Specific problem solutions have not been extended to a portfolio allowing decision makers to maximize the portfolio with specified objective functions and constraints.

The related art is represented by the following references of interest.

U.S. Patent Application Publication No. US 2001/0041995 A1, published on Nov. 21, 2001 for Jeffrey S. Edar, describes an automated system and method for evaluating the probable impact of user-specified or system generated changes in business value drivers on the other drivers, the elements of value, the real options, the financial performance and the future value of a commercial enterprise. The Edar application does not suggest a system and method for valuing investment opportunities according to the claimed invention.

U.S. Patent Application Publication No. US 2001/0053993 A1, published on Dec. 20, 2001 for Robert I. G. McLean et al., describes a data processing system and method for assessing the performance of a business enterprise in creating and realizing value. The McLean et al. application does not suggest a system and method for valuing investment opportunities according to the claimed invention.

U.S. Patent Application Publication No. US 2002/0010667 A1, published on Jan. 24, 2002 for Elaine Kant et al., describes a software synthesis method and system for providing a problem solving environment for Monte Carlo simulations which automatically transforms a problem description into executable software code. The Kant et al. application does not suggest a system and method for valuing investment opportunities according to the claimed invention.

U.S. Pat. No. 4,766,539, issued on Aug. 23, 1988 to Henry L. Fox, describes a system and method for writing a policy insuring against the occurrence of a specified weather condition. The Fox patent does not suggest a system and method for valuing investment opportunities according to the claimed invention.

U.S. Pat. No. 4,831,526, issued on May 16, 1989 to Charles M. Luchs et al., describes a fully computerized insurance system for processing and preparing applications for insurance and premium quotations and for preparing and writing insurance contracts. The Luchs et al. patent does not suggest a system and method for valuing investment opportunities according to the claimed invention.

U.S. Pat. No. 4,839,804, issued on Jan. 13, 1989 to Peter A. Roberts et al., describes a method and apparatus for insuring the funding of a future liability of uncertain cost. The Roberts et al. patent does not suggest a system and method for valuing investment opportunities according to the claimed invention.

U.S. Pat. No. 4,903,201, issued on Feb. 20, 1990 to Susan W. Wagner, describes a computerized open outcry exchange system for transacting sales of a particular futures commodity contract by members of a futures trading exchange. The Wagner patent does not suggest a system and method for valuing investment opportunities according to the claimed invention.

U.S. Pat. No. 4,975,840, issued on Dec. 4, 1990 to Arthur W. DeTore et al., describes a method and apparatus for evaluating the insurability of a potentially insurable risk. The DeTore et al. patent does not suggest a system and method for valuing investment opportunities according to the claimed invention.

U.S. Pat. No. 5,029,119, issued on Jul. 2, 1981 to Chisato Konno, describes a program generation method for generating a program which performs numerical simulation on a computer for a physical phenomenon. The Konno patent does not suggest a system and method for valuing investment opportunities according to the claimed invention.

U.S. Pat. No. 5,129,035, issued on Jul. 7, 1992 to Miyuki Saji et al., describes a method for generating a numerical calculation program which simulates a physical phenomenon represented by a partial differential equation using discretization based upon a control volume finite differential method. The Saji et al. patent does not suggest a system and method for valuing investment opportunities according to the claimed invention.

U.S. Pat. No. 5,408,638, issued on Apr. 18, 1995 to Nobutoshi Sagawa et al., describes a method of executing numerical simulation capable of reducing the number of simulation steps with simpler inputs to be designated. The Sagawa et al. '638 patent does not suggest a system and method for valuing investment opportunities according to the claimed invention.

U.S. Pat. No. 5,444,819, issued on Aug. 22, 1995 to Michiro Negishi, describes an economic phenomenon predicting and/or analyzing system using a neural network. The Negishi patent does not suggest a system and method for valuing investment opportunities according to the claimed invention.

U.S. Pat. No. 5,446,885, issued on Aug. 29, 1995 to Allan R. Moore et al., describes an event driven management information system with rule-based applications structure stored in a relational database. The Moore et al. patent does not suggest a system and method for valuing investment opportunities according to the claimed invention.

U.S. Pat. No. 5,461,699, issued on Oct. 24, 1995 to Mansur Arbabi et al., describes a system and method for forecasting that combines a neural network with a statistical forecast. The Arbabi et al. patent does not suggest a system and method for valuing investment opportunities according to the claimed invention.

U.S. Pat. No. 5,699,271, issued on Dec. 16, 1997 to Nobutoshi Sagawa et al., describes a method of automatically generating a program for solving simultaneous partial differential equations by use of the finite element method. The Sagawa et al. '271 patent does not suggest a system and method for valuing investment opportunities according to the claimed invention.

U.S. Pat. No. 5,749,785, issued on May 12, 1998 to Michael T. Rossides, describes a computer system that allows people to place, accept, and settle bets for the purpose of communicating. The Rossides patent does not suggest a system and method for valuing investment opportunities according to the claimed invention.

U.S. Pat. No. 5,752,238, issued on May 12, 1998 to Rick Dedrick, describes a computer-driven electronic information pricing mechanism including a pricing modulator and pricing interface. The Dedrick patent does not suggest a system and method for valuing investment opportunities according to the claimed invention.

U.S. Pat. No. 5,761,386, issued on Jun. 2, 1998 to Stephen R. Lawrence et al., describes a method and apparatus for the prediction of time series data. The Lawrence et al. patent does not suggest a system and method for valuing investment opportunities according to the claimed invention.

U.S. Pat. No. 5,794,207, issued on Aug. 11, 1998 to Jay S. Walker et al., describes a method and apparatus for effectuating bilateral buyer-driven commerce. The Walker et al. patent does not suggest a system and method for valuing investment opportunities according to the claimed invention.

U.S. Pat. No. 5,806,048, issued on Sep. 8, 1998 to Kenneth Kiron et al., describes a mutual fund securitization process permitting the trading of open end mutual funds and linked derivative securities on or off the floor of a National Securities Exchange. The Kiron et al. patent does not suggest a system and method for valuing investment opportunities according to the claimed invention.

U.S. Pat. No. 5,819,238, issued on Oct. 6, 1998 to Erhard R. Fernholz, describes apparatuses and methods for automatically modifying a financial portfolio having a pre-defined universe of securities through dynamic re-weighting of a position held in each security. The Fernholz patent does not suggest a system and method for valuing investment opportunities according to the claimed invention.

U.S. Pat. No. 5,845,266, issued on Dec. 1, 1998 to William A. Lupien et al., describes a crossing network that matches buy and sell orders based upon the satisfaction and quantity profile, and that includes a number of trader terminals that can be used for entering orders. The Lupien et al. patent does not suggest a system and method for valuing investment opportunities according to the claimed invention.

U.S. Pat. No. 5,873,782, issued on Feb. 23, 1999 to Grantley T. A. Hall, describes a method for providing a set price and/or variable price betting by operating on a pool of bets and ensuring that the total amount to be paid out on an outcome does not exceed the total amount available. The Hall patent does not suggest a system and method for valuing investment opportunities according to the claimed invention.

U.S. Pat. No. 5,911,136, issued on Jun. 8, 1999 to Charles A. Atkins, describes a personal financial management program for implementing, coordinating, supervising, analyzing, and reporting upon investments in an array of asset accounts and credit facilities within a credit account. The Atkins patent does not suggest a system and method for valuing investment opportunities according to the claimed invention.

U.S. Pat. No. 5,940,810, issued on Aug. 17, 1999 to Joseph F. Traub et al., describes an estimation method and system for complex securities using low-discrepancy deterministic sequences. The Traub et al. patent does not suggest a system and method for valuing investment opportunities according to the claimed invention.

U.S. Pat. No. 5,946,666, issued on Aug. 31, 1999 to Igal Nevo et al., describes an apparatus and method for monitoring financial securities markets or financial securities to provide information regarding the status of the financial securities markets or securities. The Nevo et al. patent does not suggest a system and method for valuing investment opportunities according to the claimed invention.

U.S. Pat. No. 5,970,479, issued on Oct. 19, 1999 to Ian K. Shepherd, describes methods and apparatuses which deal with the management of risk relating to, yet unknown, future events. The Shepherd patent does not suggest a system and method for valuing investment opportunities according to the claimed invention.

U.S. Pat. No. 5,978,778, issued on Nov. 2, 1999 to James P. O'Shaughnessy, describes a method for carrying out computerized selection of stocks for an investment portfolio. The O'Shoaughnessy '778 patent does not suggest a system and method for valuing investment opportunities according to the claimed invention.

U.S. Pat. No. 6,018,722, issued on Jan. 25, 2000 to Kenneth S. Ray et al., describes a computer implemented expert securities portfolio investment management system which operates as a Registered Investment Advisor. The Ray et al. patent does not suggest a system and method for valuing investment opportunities according to the claimed invention.

U.S. Pat. No. 6,064,985, issued on May 16, 2000 to Leroy E. Anderson, describes an automated portfolio management system and method which manages data in a database, and populates the database with data from a data feed of the Internet. The Anderson patent does not suggest a system and method for valuing investment opportunities according to the claimed invention.

U.S. Pat. No. 6,085,175, issued on Jul. 4, 2000 to Leon G. Gugel et al., describes a system and method for estimating value-at-risk of a financial portfolio. The Gugel et al. patent does not suggest a system and method for valuing investment opportunities according to the claimed invention.

U.S. Pat. No. 6,102,961, issued on Aug. 15, 2000 to Sherman Lee et al., describes a method and apparatus for valuing the contribution of intellectual property blocks into integrated circuit designs. The Lee et al. patent does not suggest a system and method for valuing investment opportunities according to the claimed invention.

U.S. Pat. No. 6,119,103, issued on Sep. 12, 2000 to Catherine A. Basch et al., describes a computer implemented method for predicting financial risk. The Basch et al. patent does not suggest a system and method for valuing investment opportunities according to the claimed invention.

U.S. Pat. No. 6,173,276 B1, issued on Jan. 9, 2001 to Elaine Kant et al., describes a software synthesis system and method for financial instrument modeling and valuation. The Kant et al. patent does not suggest a system and method for valuing investment opportunities according to the claimed invention.

U.S. Pat. No. 6,282,534 B1, issued on Aug. 28, 2001 to Sanjay V. Vora, describes a method for generating knowledge base entries by using a programmed computer with access to a knowledge base. The Vora patent does not suggest a system and method for valuing investment opportunities according to the claimed invention.

U.S. Pat. No. 6,317,726 B1, issued on Nov. 13, 2001 to James P. O'Shaugnessy, describes automated investment strategies for investment management. The O'Shaughnessy '726 patent does not suggest a system and method for valuing investment opportunities according to the claimed invention.

U.S. Pat. No. 6,321,212 B1, issued on Nov. 20, 2001 to Jeffrey Lange, describes methods and systems for trading and investing in groups of demand-based adjustable return contingent claims. The Lange patent does not suggest a system and method for valuing investment opportunities according to the claimed invention.

U.S. Pat. No. 6,430,542 B1, issued on Aug. 6, 2002 to William J. Moran, describes a financial planning and advice system that allows an advisor to provide proactive, efficient service to clients. The Moran patent does not suggest a system and method for valuing investment opportunities according to the claimed invention.

Great Britain Patent Application No. 2 298 299 A, published on Aug. 28, 1996 for Meyer Meinkoff, describes a portfolio selector for selecting an investment portfolio from a library of assets based on investment risk and risk-adjusted return. The Meinkoff application does not suggest a system and method for valuing investment opportunities according to the claimed invention.

Japan Patent document 64-19498, published on Jan. 23, 1989, describes an automatic paying device. The Japan document does not suggest a system and method for valuing investment opportunities according to the claimed invention.

World Intellectual Property Organization Patent Application Publication No. WO 01/53998 A1, published on Jan. 9, 2001, describes resource allocation techniques for determining an allocation of investment funds among a set of at least two asset classes for a period of time which maximizes return on the investment funds over the period of time. The WIPO application does not suggest a system and method for valuing investment opportunities according to the claimed invention.

None of the above inventions and patents, taken either singularly or in combination, is seen to describe the instant invention as claimed. Thus a system and method for valuing investment opportunities solving the aforementioned problems is desired.

### SUMMARY OF THE INVENTION

A system and method for valuing investment opportunities using real options, creating heuristics to approximately represent value, and maximizing a portfolio of investment opportunities within specified objectives and constraints. The system and method provide a problem solving environment for graphically representing complex valuation and decision problems, valuing them using real option analysis or discounted cash flow analysis, and creating heuristics between value and fundamental parameters that drive value such as cash flows, variability, probability of success, time, and choices. The system allows a user to graphically create a decision problem that allows combining options, fixed cash flows, and probabilities of technical success in whatever sequence is needed. The system also enables a user to describe parameters of the decision problem in names or in numbers in preformatted sheets or make connections to existing databases that hold the necessary information. Built in intelligence provides a user with on-demand tools to calculate the parameters needed to solve the problem.

Accordingly, it is a principal aspect of the invention to provide a system for valuing investment opportunities that includes a central processing unit (CPU), a memory, an output device, and computer readable program code means stored in the memory, or a computer useable medium having computer readable program code means embodied thereon, the computer readable program code means including first instruction means for providing a window image on a display device for obtaining input data regarding a problem, second instruction means for parameterizing input data regarding a problem, the parameterized input data including names or numbers, third instruction means for adding, deleting, and/or inserting data regarding a problem, fourth instruction means for providing a graphical interface to frame a problem based on parameterized input data, fifth instruction means for executing a stochastic simulation of various entities for a problem based on parameterized input data, sixth instruction means for solving a discounted cash flow problem using simulation, seventh instruction means for solving a real options problem using simulation, eighth instruction means for providing results of a problem based on parameterized input data in both text and graphical form for a problem based on parameterized input data, ninth instruction means for determining a net present value of an option in a problem based on parameterized input data, tenth instruction means for determining a real options value of an option in a problem based on parameterized input data, eleventh instruction means for determining heuristic parameters of an option in a problem based on parameterized input data, twelfth instruction means for executing a sensitivity analysis on an option in a problem based on parameterized input data, and thirteenth instruction means for executing an impact analysis on an option in a problem based on parameterized input data.

It is another aspect of the invention to provide a system for valuing investment opportunities that includes a CPU, a memory, an output device, and computer readable program code means stored in the memory, or a computer useable medium having computer readable program code means embodied thereon, the computer readable program code means including fourteenth instruction means for executing a stochastic simulation of various entities for a problem based on parameterized input data, the stochastic simulation including geometric brownian motion functions, fifteenth instruction means for executing a stochastic simulation of various entities for a problem based on parameterized input data, the stochastic simulation including mean reverting functions, sixteenth instruction means for executing a stochastic simulation of various entities for a problem based on parameterized input data, the stochastic simulation including mean square reverting functions, and seventeenth instruction means for executing a real options simulation, the real options simulation including preprocessing of parameterized input data by executing a Monte Carlo simulation on parameterized input data.

It is a further aspect of the invention to provide a system for valuing investment opportunities that includes a CPU, a memory, an output device, and computer readable program code means stored in the memory, or a computer useable medium having computer readable program code means embodied thereon, the computer readable program code means including eighteenth instruction means for determining results that indicate skewness, nineteenth instruction means for determining results that indicate kurtosis, twentieth instruction means for determining results that indicate standard error, twenty-first instruction means for providing graphical outputs showing sensitivity distributions, twenty-second instruction means for providing graphical outputs showing impact distributions, and twenty-third instruction means for providing graphical outputs showing probability distributions.

Still another aspect of the invention is to provide a method for valuing investment opportunities., the method providing a window image on a display device for obtaining input data regarding a problem, parameterizing input data regarding a problem, the parameterized input data including names or numbers, adding, deleting, and/or inserting data regarding a problem, providing a graphical interface to frame a problem based on parameterized input data, executing a stochastic simulation of various entities for a problem based on parameterized input data, solving a discounted cash flow problem using simulation, solving a real options problem using simulation, providing results of a problem based on parameterized input data in both text and graphical form, for a problem based on parameterized input data, determining a net present value of an option in a problem based on parameterized input data, determining a real options value of an option in a problem based on parameterized input data, determining heuristic parameters of an option in a problem based on parameterized input data, executing a sensitivity analysis on an option in a problem based on parameterized input data, and executing an impact analysis on an option in a problem based on parameterized input data.

Yet another aspect of the invention is to provide a method for valuing investment opportunities system, the method executing a stochastic simulation of various entities for a problem based on parameterized input data, the stochastic simulation including geometric brownian motion functions, executing a stochastic simulation of various entities for a problem based on parameterized input data, the stochastic simulation including mean reverting functions, executing a stochastic simulation of various entities for a problem based on parameterized input data, the stochastic simulation including mean square reverting functions, executing a real options simulation, the real options simulation including preprocessing of parameterized input data, and executing a real options simulation, the real options simulation including preprocessing of parameterized input data by executing a Monte Carlo simulation on parameterized input data.

Still another aspect of the invention is to provide a method for valuing investment opportunities, the method determining results that indicate skewness, determining results that indicate kurtosis, determining results that indicate standard error, providing graphical outputs showing sensitivity distributions. providing graphical outputs showing impact distributions, and providing graphical outputs showing probability distributions.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front perspective view of a computer system equipped computer readable program code means for valuing investment opportunities according to the present invention.

FIG. 2 is a block diagram of a computer system equipped computer readable program code means for valuing investment opportunities according to the present invention.

FIG. 3 is a graphical model of a representation of a valuation problem according to the present invention.

FIG. 4 is a total value build up graph according to the present invention.

FIG. 5 is a total value break-up graph according to the present invention.

FIG. 6 is a trigger boundary graph with two stochastic functions according to the present invention.

FIG. 7 is a trigger boundary graph with three stochastic functions according to the present invention.

FIG. 8 is an impact graph according to the present invention.

FIG. 9 is a sensitivity graph according to the present invention.

FIG. 10 is a sample simulation of an asset according to the present invention.

FIG. 11 is a value distribution graph according to the present invention.

FIG. 12 is a portfolio graph according to the present invention.

Similar reference characters denote corresponding features consistently throughout the attached drawings.

### DETAILED DESCRIPTION OF THE PREFERRED EMBODIMENTS

The present invention is a system and method for valuing investment opportunities using real options, creating heuristics to approximately represent value, and maximizing a portfolio of investment opportunities within specified objectives and constraints. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

The system and method for valuing investment opportunities according to the present invention provides an integrated modeling and problem solving environment for the valuation of real assets or investment choices, creation of heuristics that describes value and maximizes a portfolio of such assets or investment choices. The system is integrated with a knowledge base of external data to help create the necessary parameters that describe the problem. It also provides a graphical interface to model complex valuation problems that involve multiple real options, cash flows, and technical probabilities.

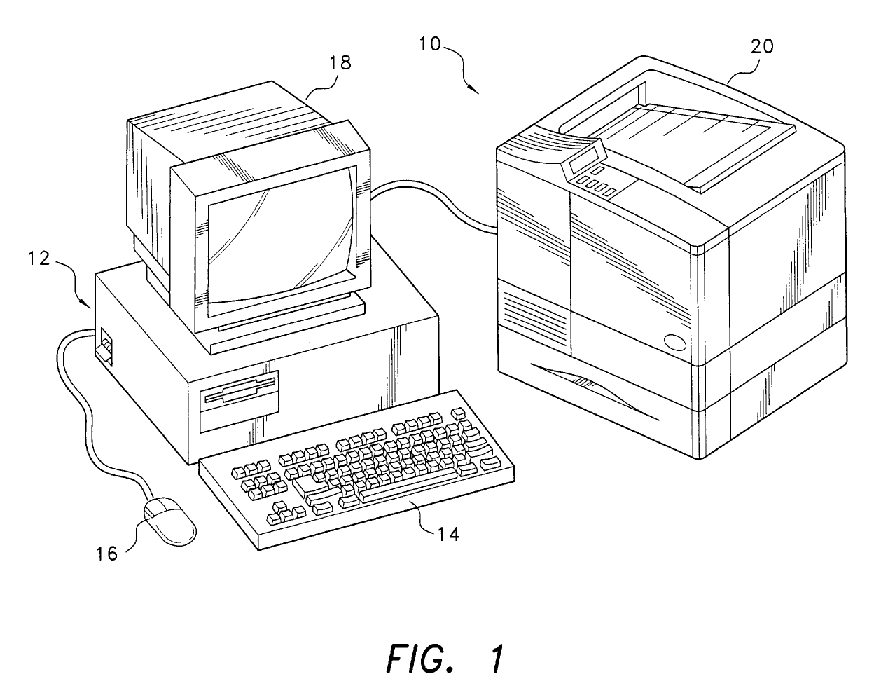

Referring to the drawings, FIG. 1 illustrates a system 10 for valuing investment opportunities using real options, creating heuristics to approximately represent value, and maximizing a portfolio of investment opportunities within specified objectives and constraints includes a computer system configured for carrying out the present invention.

System 10 may include any type of known computer, such as a personal computer or the like. Alternatively, system 10 may be functioning as a server/database on a web site via the internet. As shown in FIG. 1, system 10 is configured for carrying out the present invention and includes a computer 12, input devices 14, 16, a display 18, and a printer 20. Input devices 14 and 16 are illustrates as a keyboard and a mouse, respectively. However, any input device may be employed according to the desires of the user. Display 18 may be any known display device, such as a cathode ray tube, a liquid crystal display, or the like. Printer 20 may be any known printing device. Additional components of an exemplary data visualization apparatus 10 comprising a digital computer are illustrated.

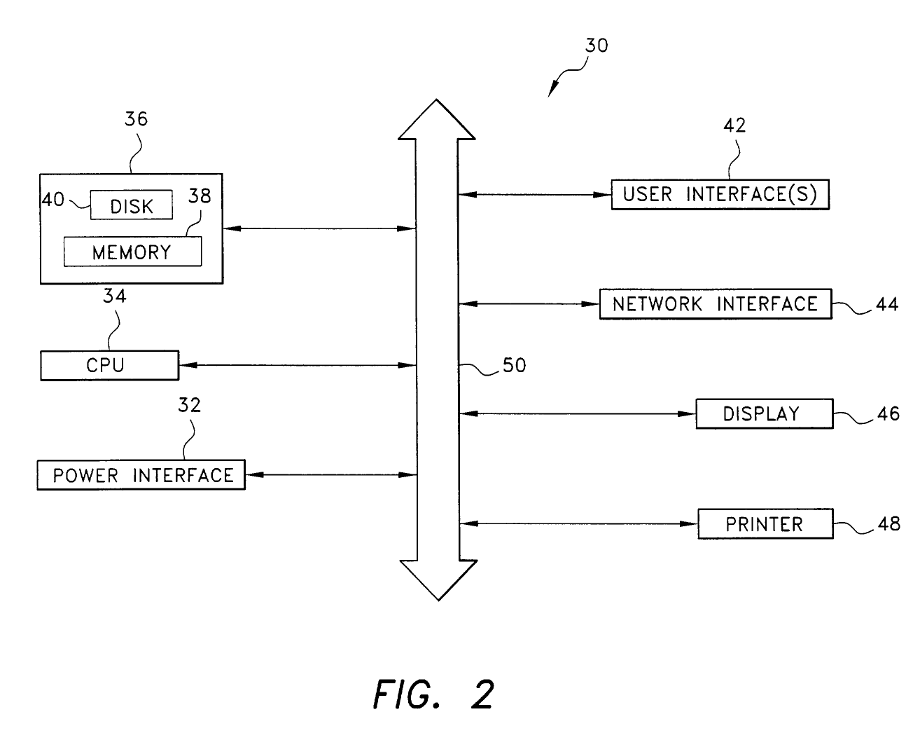

In FIG. 2, an illustrated configuration of a computer 30 includes a power interface 32, a CPU 34, a memory 36, a user interface(s) 42, a network interface 44, a display 46, and a printer 48, that are all communicatively interconnected by a communication bus 50. In the illustrated configuration, memory 30 includes memory 38 and disk storage device 40. Memory 30 represents computer useable media configured to store computer readable program code means and data. Exemplary memory 38 includes RAM and ROM. Exemplary disk storage devices 40 may include floppy disks, hard disks, CD-ROM devices, or the like.

The ROM stores computer readable program code means that is read and processed by CPU 34, and that causes CPU 34 to perform programmed functions. Movement and process of instructions as well as data is controlled and accomplished by CPU 34. The RAM and the ROM may be connected to the microprocessor through several signal paths.

CPU 34 may execute various programs under the control of the operating system of computer 30. The application program of the present invention may be configured for use with known graphical software applications, such as EXCEL™ or the like. Any computer readable program code means stored in the memory of computer 30, or a computer useable medium having computer readable code means embodied thereon may include first instruction means for providing a window image on a display device for obtaining input data regarding a problem; second instruction means for parameterizing input data regarding a problem, the parameterized input data including names or numbers; third instruction means for adding, deleting, and/or inserting data regarding a problem; fourth instruction means for providing a graphical interface to frame a problem based on parameterized input data; fifth instruction means for executing a stochastic simulation of various entities for a problem based on parameterized input data; sixth instruction means for solving a discounted cash flow problem using simulation; seventh instruction means for solving a real options problem using simulation; eighth instruction means for providing results of a problem based on parameterized input data in both text and graphical form for a problem based on parameterized input data; ninth instruction means for determining a net present value of an option in a problem based on parameterized input data; tenth instruction means for determining a real options value of an option in a problem based on parameterized input data; eleventh instruction means for determining heuristic parameters of an option in a problem based on parameterized input data; twelfth instruction means for executing a sensitivity analysis on an option in a problem based on parameterized input data; and thirteenth instruction means for executing an impact analysis on an option in a problem based on parameterized input data.

Any computer readable program code means stored in the memory of computer 30, or a computer useable medium having computer readable code means embodied thereon may also include fourteenth instruction means for executing a stochastic simulation of various entities for a problem based on parameterized input data, the stochastic simulation including geometric brownian motion functions; fifteenth instruction means for executing a stochastic simulation of various entities for a problem based on parameterized input data, the stochastic simulation including mean reverting functions; sixteenth instruction means for executing a stochastic simulation of various entities for a problem based on parameterized input data, the stochastic simulation including mean square reverting functions; and seventeenth instruction means for executing a real options simulation, the real options simulation including preprocessing of parameterized input data by executing a Monte Carlo simulation on parameterized input data.

Any computer readable program code means stored in the memory of computer 30, or a computer useable medium having computer readable code means embodied thereon may also include eighteenth instruction means for determining results that indicate skewness; nineteenth instruction means for determining results that indicate kurtosis; twentieth instruction means for determining results that indicate standard error; twenty-first instruction means for providing graphical outputs showing sensitivity distributions; twenty-second instruction means for providing graphical outputs showing impact distributions; and twenty-third instruction means for providing graphical outputs showing probability distributions.

The interface to the system is graphical software with preformatted sheets and a tool bar that allows easy modeling with color coded blocks and parameters of various decision components. The options, cash flows, and technical outcomes that may be present may be connected together in a visually pleasing way to describe the timing and sequencing of them relative to each other. Within each block, the parameters that describe them may be provided either by using names or by specifying them in numbers (if they are deterministic). The timing may be relative to each other or in absolute terms (by specifying the actual year and months).

Because of its modular construction, the system allows easy addition, deletion, and insertion of individual, as well as group, of components into the decision schema. All of this may be accomplished within the integrated framework. Stochastic and probabilistic variables may be prescribed by using built-in functions. The numerical precision of the solution may be controlled through a number of time steps, number of iterations, and the degree of polynomial fit.

The problem specification has components including stochastic functions, probability distributions, heuristic parameter ranges, and graphical modeling.

Stochastic functions may be specified using built in functions (geometric brownian motion, mean reverting, mean square reverting, or the like functions) or as an Ito process with controllable drift and diffusion characteristics. Additionally, dividends may be specified for geometric brownian motion, long term mean, and reversion rates for the mean reverting and mean square reverting processes. All processes may include poisson jumps to model arrival of random events and associated jumps in value. Many stochastic functions of various characteristics may be prescribed (limited by a computer's memory) and correlations may be specified among them.

Probability functions may be specified to represent cash flows or technical success at various points of the decision schema. Built in functions are available to choose from.

There are two ways to create heuristics of a problem being solved. In the first method, the system varies the parameters randomly within specified limits and solves for a value. After completing the valuation for many combinations of parameters, the first method fits a polynomial to define the relationship. In the second method, the user specifies combinations of the parameters that need to be tried.

There are two types of options and many types of operators that may be used to define a decision or valuation problem graphically. Each of these provides a color coded block in which important parameters can be defined. They can be linked together to show the sequencing of the decisions. Timing can be specified either relative to preceding blocks or on absolute terms.

Valuation problems employing real options often require preprocessing of available data. They may also require simulation to calculate initial value and volatility of assets. Functions are provided and a simulation functionality to run Monte Carlo simulation for this preprocessing phase.

Preformatted sheets are provided to collect appropriate data inputs. The program also allows a user to draw out a decision problem using a toolbar. Users can access the program on a server over the web. All the functionalities of the program are available this way.

Numerical results that show value and various characteristics of value such as skewness, kurtosis, and standard error are provided. Additionally, a variety of graphical outputs are also available for sensitivity, impact, and probability distributions.

The knowledge base that allows users to create parameters for the valuation resides in the program. The code that allows the user to process this data is written in any known software language according to the desires of the operator. The knowledge base contains updatable market data of specific stocks, indexes and sectors. Based on this parameter, volatility that is used in real options analysis is calculated by the system. Users specify the sector or area that proxy the investment problem being solved.

The system incorporates multiple built in calculators to calculate parameters such as initial value. The system also provides a calculator for volatility when market data is not readily available and volatility needs to be inputted from expert opinions. Additionally, from a drop down menu, users are able to select the characteristics of the stochastic processes and probability distributions.

The system provides the (a) ability to form and solve a wide class of valuation and design problems; (b) modularity to incorporate a variety of types of decisions, cash flows, and technical risk; (c) explicit control over numerical precision of the results through number of time steps, number of iterations, and degree of polynomial fit; (d) ability to automatically create heuristics from a framed problem through randomization and regression; (e) ability to automatically find sensitivity and impact analysis from a framed problem; and (f) ability to automatically diagnose problems that may exist in problem formulation, framing, and parameterization.

A stepwise numerical approximation is performed according to the following:

(a) for geometric brownian motion:

dp=drift*p*dt+volatility*p*dW

(b) for mean reversion:

dp=reversion*(lt_{—}mean−p)*dt+volatility*p*dW

(c) for mean square reversion:

dp=reversion*(lt_{—}mean−p)*dt+volatility*sqrt(p)*dW

(d) generalized Ito:

dp=drift_{—}functon*dp+diffusion_{—}function*dt

where p=price

dp=change in price

dt=time step

volatility=standard deviation of historical price changes

dW=increment of a standard Weiner process reversion=rate of mean reversion

lt_mean=long run mean of price

drift_function=function representing the drift term

diffusion_function=function representing the diffusion term.

If poisson jumps are present, the probability of a poisson jump is calculated for each step. The arrival of the event is simulated. If the event arrives, the price is multiplied by the loss factor. If correlation exists between processes, a first process is simulated according to the stochastic simulation procedure described above. Then a second process is simulated with the diffusion component in each time step correlated (equal to the correlation specified).

At each decision point, the value is a function of the value of subsequent decisions contingent on the observed value of the relevant stochastic functions. Continuation value is calculated using polynomial fitting of the Monte Carlo simulation paths.

Valuation is conducted for a large number of random combinations of fundamental factors. A polynomial fit is employed between value and the fundamental factors to derive the heuristic.

By combining investment problems described this way, the present invention also provides functionality to create a portfolio and maximize the portfolio for user specified criteria and constraints.

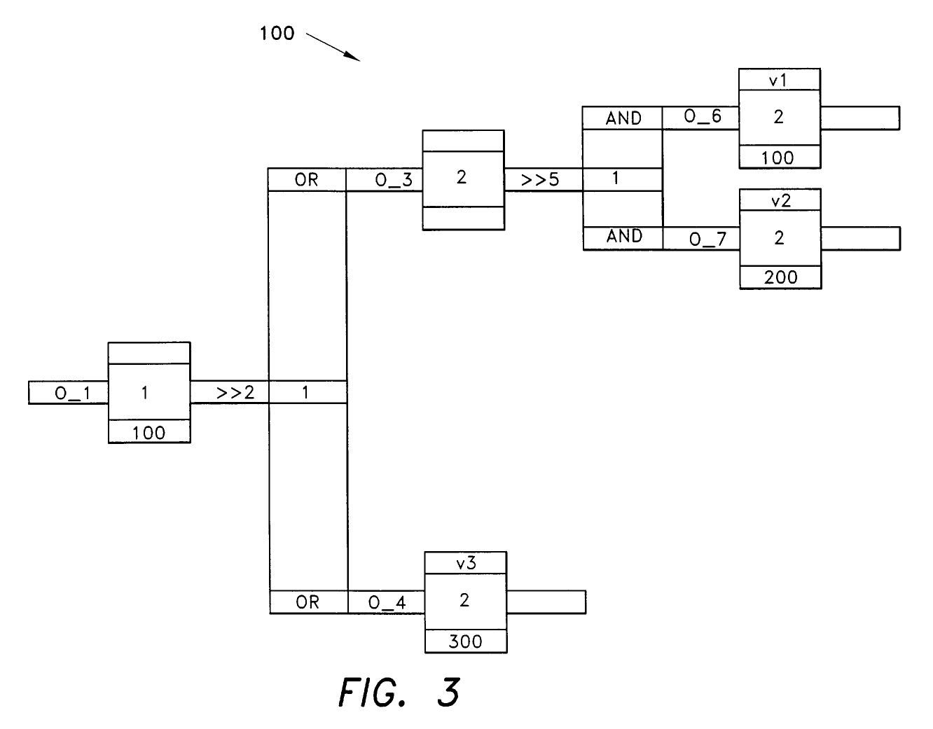

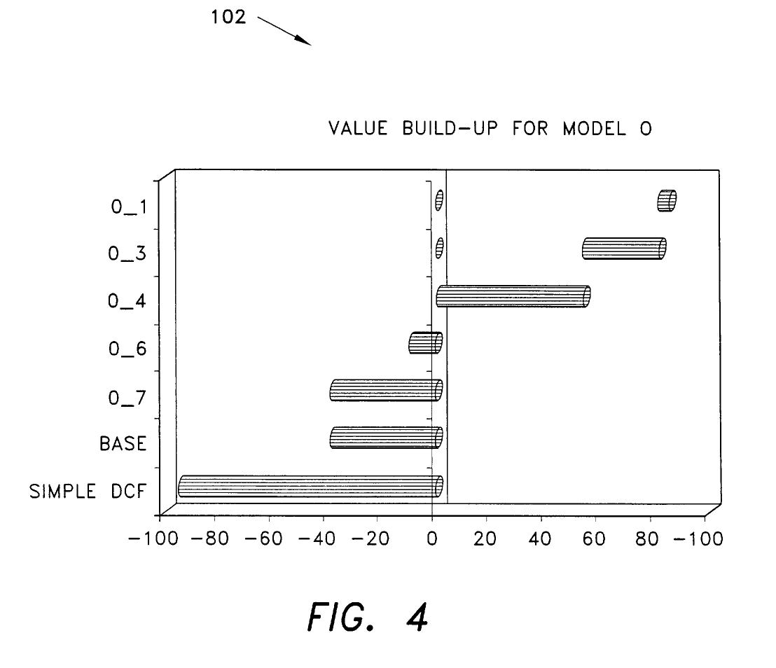

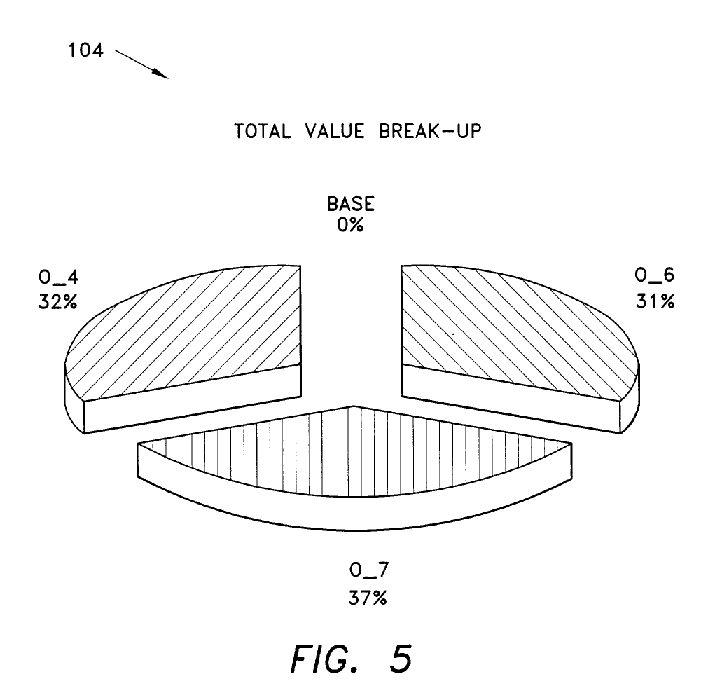

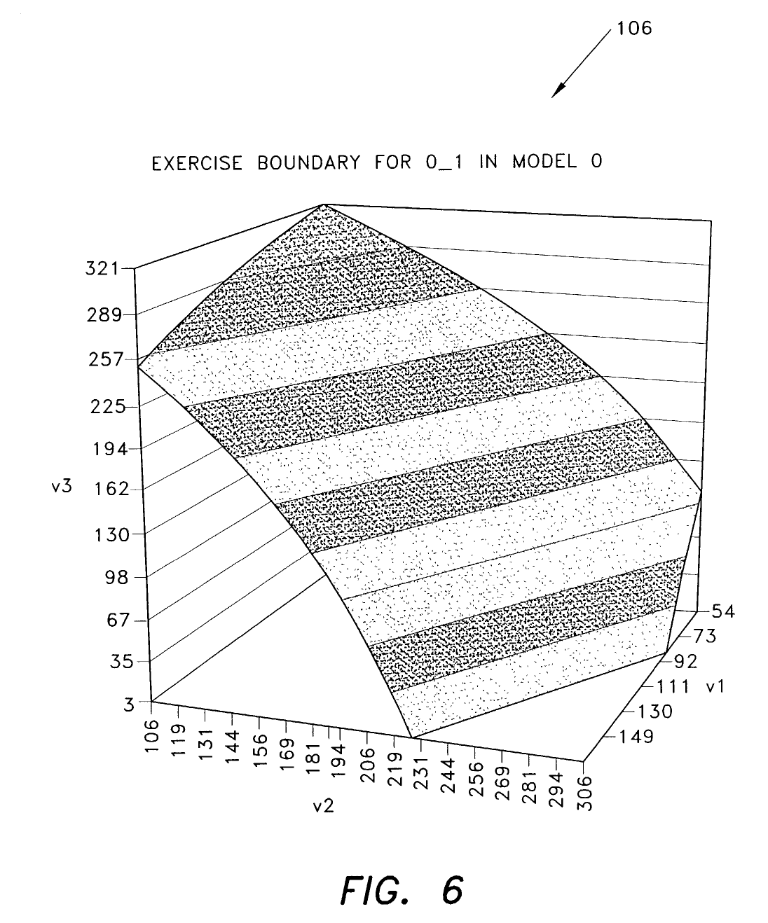

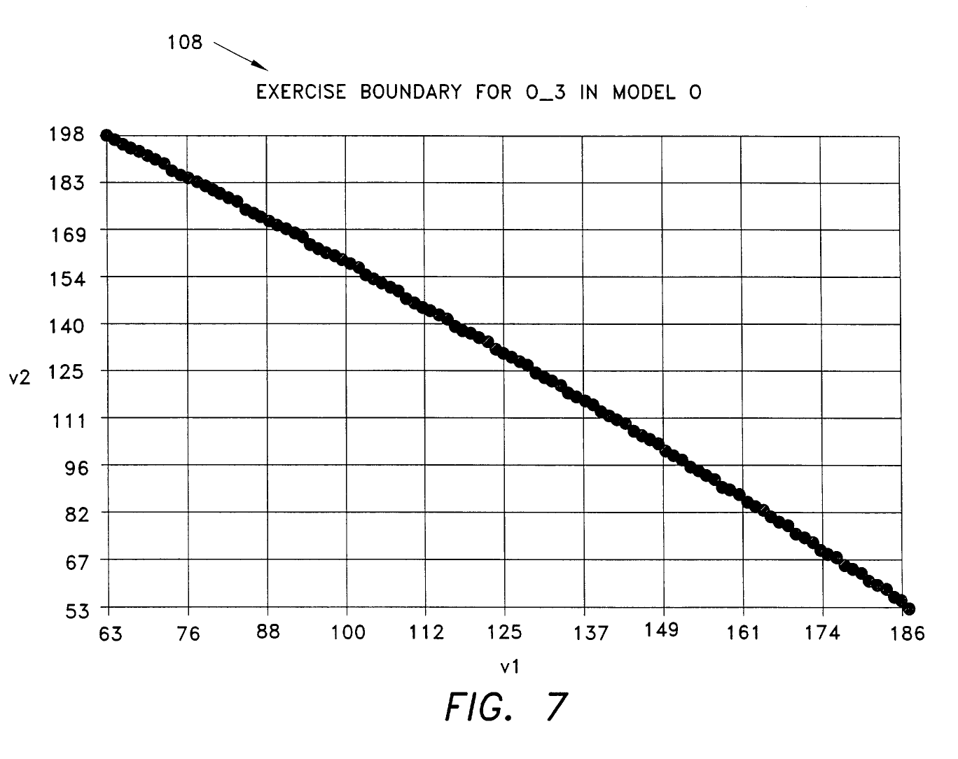

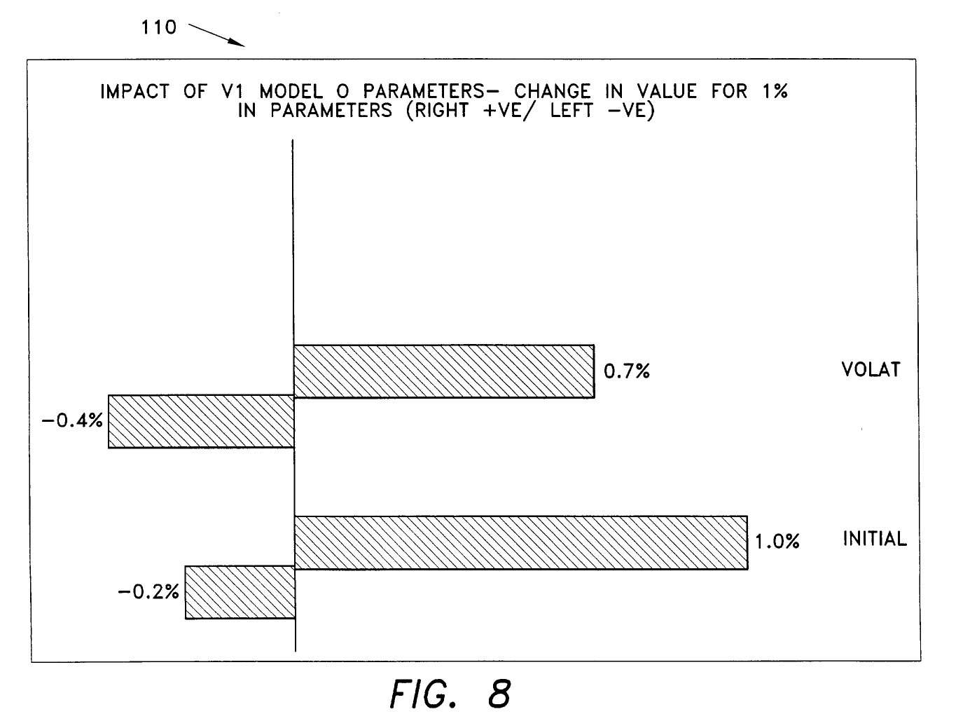

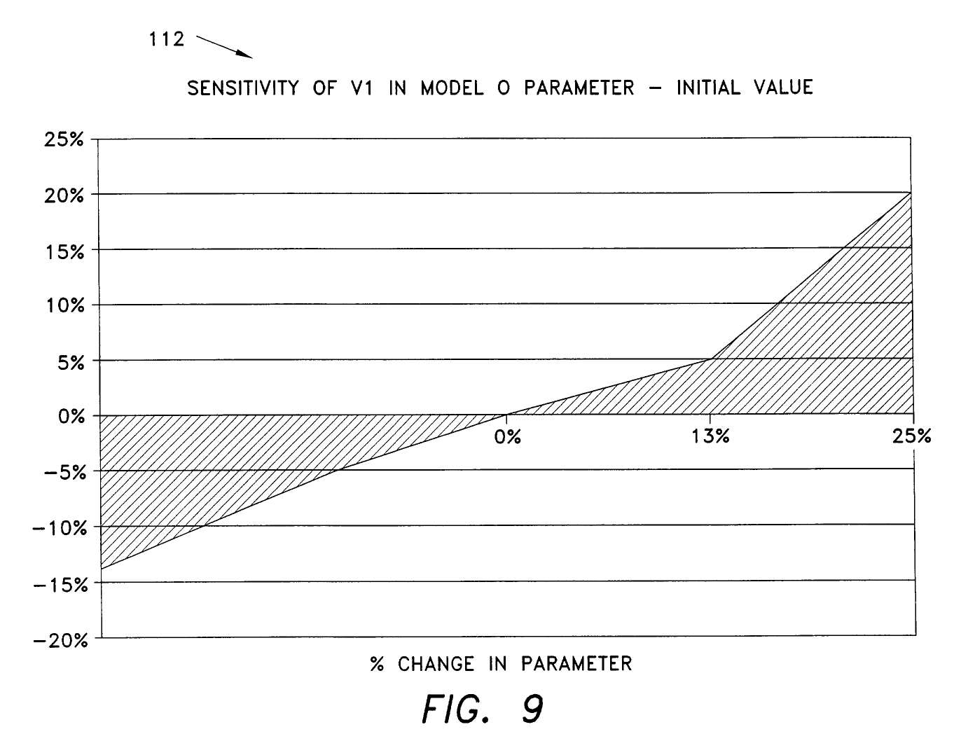

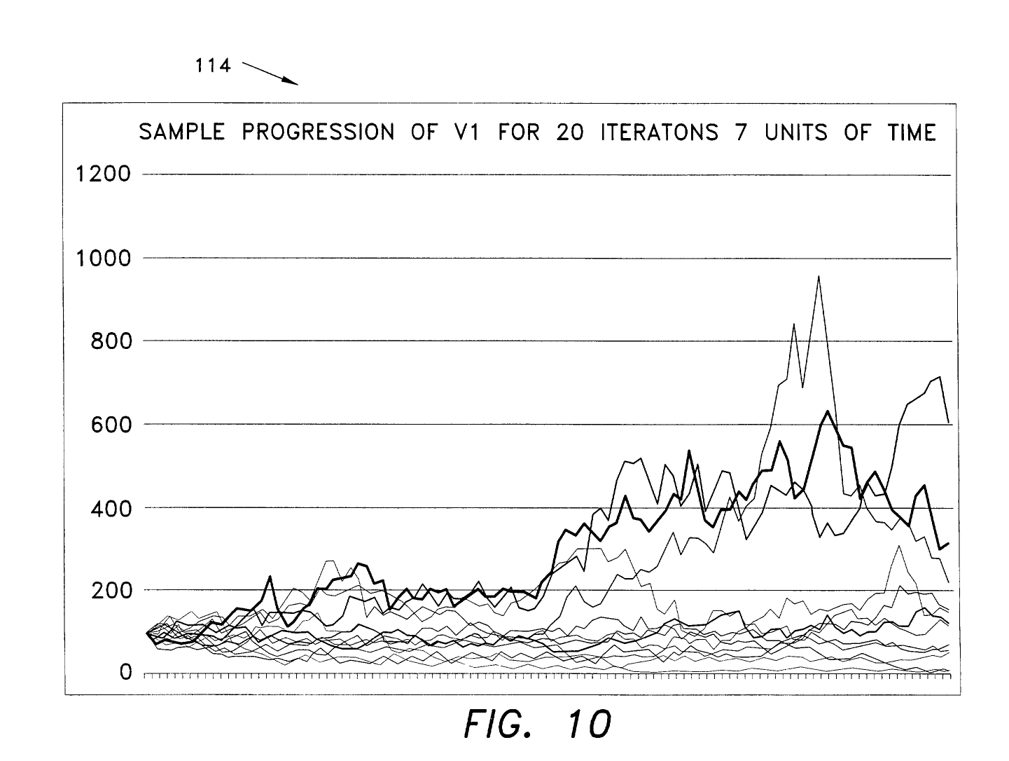

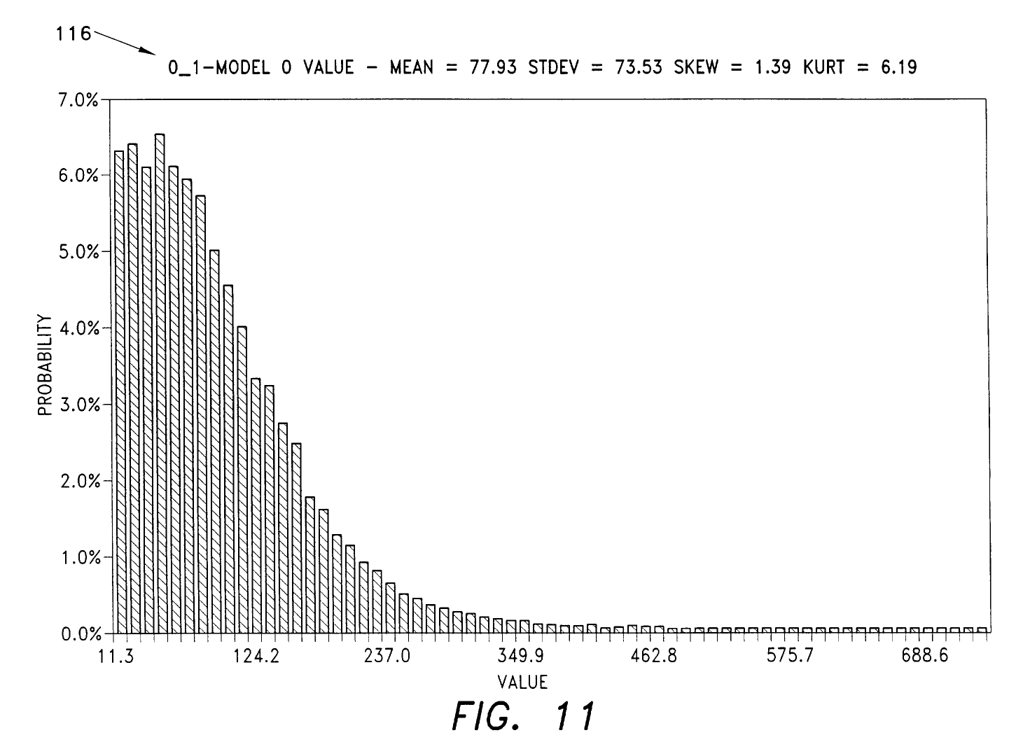

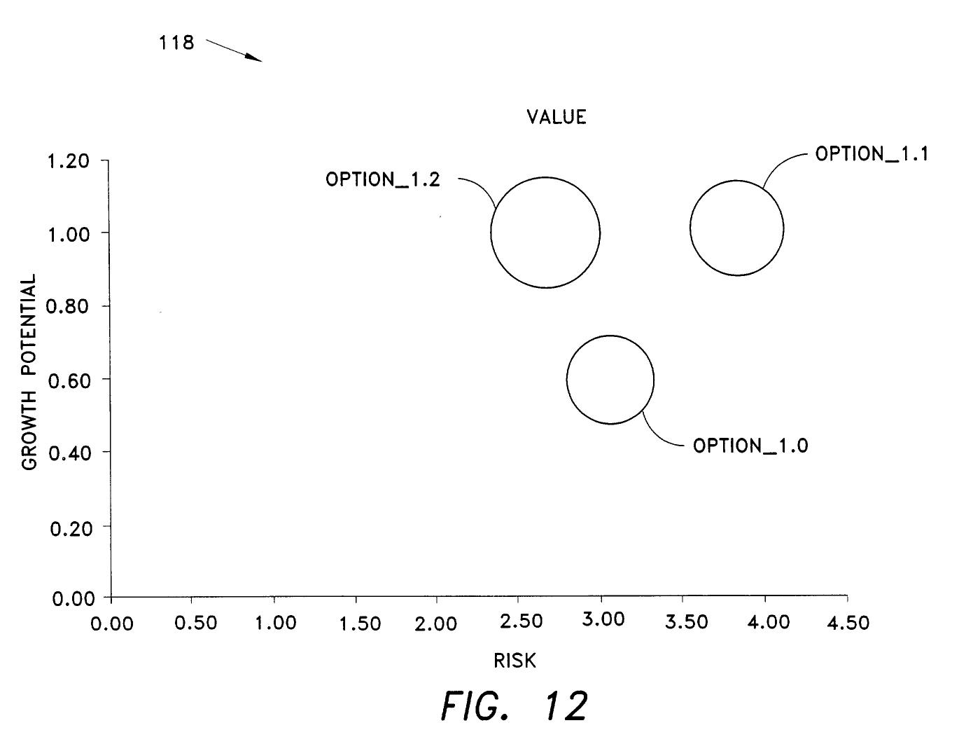

FIG. 3 shows a model 100 of a value option according to the present invention. FIG. 4 shows a total value build up graph 102 according to the present invention. FIG. 5 shows a total value break-up graph 104 according to the present invention. FIG. 6 shows a trigger boundary graph 106 with two stochastic functions according to the present invention. FIG. 7 shows a trigger boundary graph 108 with three stochastic functions according to the present invention. FIG. 8 shows an impact graph 110 according to the present invention. FIG. 9 shows a sensitivity graph 112 according to the present invention. FIG. 10 shows a sample simulation 114 of an asset according to the present invention. FIG. 11 shows a value distribution graph 116 according to the present invention. FIG. 12 shows a portfolio graph 118 according to the present invention.

A method for valuing investment opportunities using real options, creating heuristics to approximately represent value, and maximizing a portfolio of investment opportunities within specified objectives and constraints provides a window image on a display device for obtaining input data regarding a problem. Input data regarding the problem is then parameterized. The parameterized input data includes names or numbers. Data regarding a problem may be added, deleted, and/or inserted for a problem.

A graphical interface is provided to frame a problem based on the parameterized input data. A stochastic simulation of various entities may be executed for the problem based on parameterized input data. A discounted cash flow problem may be solved for the problem using simulation.

Results of the problem may be provided based on parameterized input data in both text and graphical form. A net present value of an option of the problem may be determined. A real options value may be determined for an option of the problem. Heuristic parameters may be determined for an option of the problem. A sensitivity analysis may be executed for an option in the problem. An impact analysis may be executed on an option in the problem.

The method may also include executing a stochastic simulation of various entities for the problem, the stochastic simulation including geometric brownian motion functions. A stochastic simulation including mean reverting or mean square reverting functions may also be executed for various entities of the problem. A real options analysis with a Monte Carlo simulation on parameterized input data may also be executed.

Results indicating skewness may also be determined. Results indicating kurtosis may also be determined. Results indicating standard error may also be determined. Graphical outputs showing sensitivity distributions may be provided. Graphical outputs showing impact distributions may also be provided. Graphical outputs showing probability distributions may also be provided.

While the invention has been described with references to its preferred embodiment, it will be understood by those skilled in the art that various changes may be made and equivalents may be substituted for elements thereof without departing from the true spirit and scope of the invention.

I claim:

1. A system for valuing investment opportunities comprising:
a central processing unit;
a memory;
an output device;
computer readable program code means stored in said memory, said computer readable program code means comprising:
first instruction means for providing a window image on a display device for obtaining input data regarding a problem;
second instruction means for parameterizing input data regarding a problem, the parameterized input data including names or numbers;
third instruction means for adding, deleting, and/or inserting data regarding a problem;
fourth instruction means for providing a graphical interface to frame a problem based on parameterized input data;
fifth instruction means for executing a stochastic simulation of various entities for a problem based on parameterized input data;
sixth instruction means for solving a discounted cash flow problem using simulation;
seventh instruction means for solving a real options problem using simulation;
eighth instruction means for providing results of a problem based on parameterized input data in both text and graphical form for a problem based on parameterized input data;
ninth instruction means for determining a net present value of an option in a problem based on parameterized input data;
tenth instruction means for determining a real options value of an option in a problem based on parameterized input data;
eleventh instruction means for determining heuristic parameters of an option in a problem based on parameterized input data;
twelfth instruction means for executing a sensitivity analysis on an option in a problem based on parameterized input data; and
thirteenth instruction means for executing an impact analysis on an option in a problem based on parameterized input data.

2. The system for valuing investment opportunities according to claim 1, wherein said computer readable program code means further comprises:
fourteenth instruction means for executing a stochastic simulation of various entities for a problem based on parameterized input data, the stochastic simulation including geometric brownian motion functions;
fifteenth instruction means for executing a stochastic simulation of various entities for a problem based on parameterized input data, the stochastic simulation including mean reverting functions;
sixteenth instruction means for executing a stochastic simulation of various entities for a problem based on parameterized input data, the stochastic simulation including mean square reverting functions; and
seventeenth instruction means for executing a real options simulation, the real options simulation including preprocessing of parameterized input data by executing a Monte Carlo simulation on parameterized input data.

3. The system for valuing investment opportunities according to claim 1, wherein said computer readable program code means further comprises:
eighteenth instruction means for determining results that indicate skewness;
nineteenth instruction means for determining results that indicate kurtosis;
twentieth instruction means for determining results that indicate standard error;
twenty-first instruction means for providing graphical outputs showing sensitivity distributions;
twenty-second instruction means for providing graphical outputs showing impact distributions; and
twenty-third instruction means for providing graphical outputs showing probability distributions.

4. A computer useable medium having computer readable program code means embodied thereon, said computer readable program code means comprising:
first instruction means for providing a window image on a display device for obtaining input data regarding a problem;
second instruction means for parameterizing input data regarding a problem, the parameterized input data including names or numbers;
third instruction means for adding, deleting, and/or inserting data regarding a problem;
fourth instruction means for providing a graphical interface to frame a problem based on parameterized input data;
fifth instruction means for executing a stochastic simulation of various entities for a problem based on parameterized input data;
sixth instruction means for solving a discounted cash flow problem using simulation;
seventh instruction means for solving a real options problem using simulation;
eighth instruction means for providing results of a problem based on parameterized input data in both text and graphical form for a problem based on parameterized input data;
ninth instruction means for determining a net present value of an option in a problem based on parameterized input data;
tenth instruction means for determining a real options value of an option in a problem based on parameterized input data;
eleventh instruction means for determining heuristic parameters of an option in a problem based on parameterized input data;
twelfth instruction means for executing a sensitivity analysis on an option in a problem based on parameterized input data; and
thirteenth instruction means for executing an impact analysis on an option in a problem based on parameterized input data.

5. The computer readable medium according to claim 4, wherein said computer readable program code means further comprises:
fourteenth instruction means for executing a stochastic simulation of various entities for a problem based on parameterized input data, the stochastic simulation including geometric brownian motion functions;
fifteenth instruction means for executing a stochastic simulation of various entities for a problem based on parameterized input data, the stochastic simulation including mean reverting functions;
sixteenth instruction means for executing a stochastic simulation of various entities for a problem based on parameterized input data, the stochastic simulation including mean square reverting functions; and
seventeenth instruction means for executing a real options simulation, the real options simulation including preprocessing of parameterized input data by executing a Monte Carlo simulation on parameterized input data.

6. The computer readable medium according to claim 4, wherein said computer readable program code means further comprises:
eighteenth instruction means for determining results that indicate skewness;
nineteenth instruction means for determining results that indicate kurtosis;
twentieth instruction means for determining results that indicate standard error;
twenty-first instruction means for providing graphical outputs showing sensitivity distributions;
twenty-second instruction means for providing graphical outputs showing impact distributions; and
twenty-third instruction means for providing graphical outputs showing probability distributions.

7. A method for valuing investment opportunities, said method comprising:
providing a window image on a display device for obtaining input data regarding a problem;
parameterizing input data regarding a problem, the parameterized input data including names or numbers;
adding, deleting, and/or inserting data regarding a problem;
providing a graphical interface to frame a problem based on parameterized input data;
executing a stochastic simulation of various entities for a problem based on parameterized input data;
solving a discounted cash flow problem using simulation;
solving a real options problem using simulation;
providing results of a problem based on parameterized input data in both text and graphical form;
for a problem based on parameterized input data;
determining a net present value of an option in a problem based on parameterized input data;
determining a real options value of an option in a problem based on parameterized input data;
determining heuristic parameters of an option in a problem based on parameterized input data;
executing a sensitivity analysis on an option in a problem based on parameterized input data; and
executing an impact analysis on an option in a problem based on parameterized input data.

8. The method for valuing investment opportunities system according to claim 7, further comprising:
executing a stochastic simulation of various entities for a problem based on parameterized input data, the stochastic simulation including geometric brownian motion functions;
executing a stochastic simulation of various entities for a problem based on parameterized input data, the stochastic simulation including mean reverting functions;
executing a stochastic simulation of various entities for a problem based on parameterized input data, the stochastic simulation including mean square reverting functions; and
executing a real options simulation, the real options simulation including preprocessing of parameterized input data by executing a Monte Carlo simulation on parameterized input data.

9. The method for valuing investment opportunities according to claim 7, further comprising:
determining results that indicate skewness;
determining results that indicate kurtosis;
determining results that indicate standard error;
providing graphical outputs showing sensitivity distributions;
providing graphical outputs showing impact distributions; and
providing graphical outputs showing probability distributions.
